(19) United States
(12) Patent Application Publication
(10) Pub. No.: US 2003/0209328 A1
(43) Pub. Date: Nov. 13, 2003

(54) Label-pasting mechanism for CDs

(76) Inventor: Kuo Hwa Tseng, Taoyuan (TW)

Correspondence Address: BRUCH E. TROXELL, TROXELL LAW OFFICE PLLC, Suite 1404, 5205 Leesburg Pike, Falls Church, VA, 22041, US

(21) Appl. No.: 10/140,177

(22) Filed: May 8, 2002

(51) Int. Cl. B32B 1/00

(52) U.S. Cl. 156/391

(57) ABSTRACT

The present invention relates to a label-pasting mechanism designed for CDs. After the label is pasted on the CD initially, you can contact the contacting area of the label-pasting mechanism with the label and move by the contacting area by holding the central column, which allows the label to paste completely on the CD. Pasting the label by the label-pasting mechanism enhances the convenience of pasting the label by yourself as well as improves the difficulty in writing and filing of the CD, which then satisfies the need for writing, recording and filing. Beside, using different color of labels to distinguish the CDs promotes the convenience in usage.

### FIELD OF THE INVENTION

The present invention is a label-pasting mechanism designed for labels pasted on CDs, especially the mechanism that pastes labels on an adequate surface of CDs with complete accuracy. In addition, users can write on the labels, which improves the convenience of filing and classification.

### BACKGROUND OF THE INVENTION

The rapidly advancing technology brings significant improvement in the functions of each type of the electronic products. Among these products, computer has become one of the indispensable equipment nowadays. With the popularization of the computer, the use of CDs has increased significantly. In the meantime, the use of CD burners also brings forth extensive use of CDs. Under these conditions, how to manage and file CDs more effectively is still a problem needing improvement.

Common CDs are coated with a layer of painting on the surface with the space for writing separated out. However, the surface of the CD is too glossy to write with an ordinary pen but the marker pen. Otherwise, the label pasted on the surface of the CD for writing is restricted by the space of the label or the writing range of the marker pen that causes inconvenience in using and skimming through and searching during filing.

In view of this, the inventor of the present invention researched and improved the inconvenience in writing, filing and searching by providing a mechanism that marks the CD with the label for filing in accordance with the user's self requirements.

### SUMMARY OF THE INVENTION

The objective of the present invention is to provide a label-pasting mechanism that paste the label rapidly and accurately on the surface of the CD with the flat contacting area of the label-pasting mechanism that touches the label completely and closely to paste the label entirely on the CD. Due to the large label pasted on the CD, the user can write with any pens. Also, the color of the paste that distinguishes the CD clearly enhances the convenience of filing and searching.

### BRIEF DESCRIPTION OF THE DRAWINGS

FIG. 1 is a three-dimensional illustration of the appearance for the present invention.

FIG. 2 is a three-dimensional illustration of the appearance for the present invention from another angle.

FIG. 3 is a plan of using the present invention.

FIG. 4 is an illustration of the label pasted completely and closely on the surface of the CD by the present invention.

### DETAILED DESCRIPTION OF THE DRAWINGS

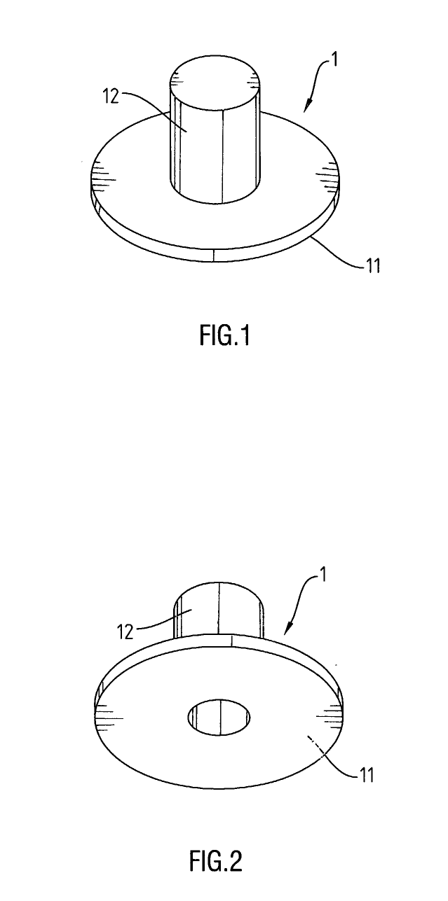

Please refer to FIGS. 1 to 3. The label-pasting mechanism 1 of the present invention is shaped with a column standing at the center of the circular base. The label-pasting mechanism 1 consists of the contacting area 11 and the central column 12 whose diameter equals to the circular hold 31 of the CD. The protruding column is designed for holding as well as provides the positioning function when passing through the circular hole 31 of the CD 3. The contacting area 11 is a flat surface, allowing the label 2 to be pasted on the surface of the CD 3 completely and closely.

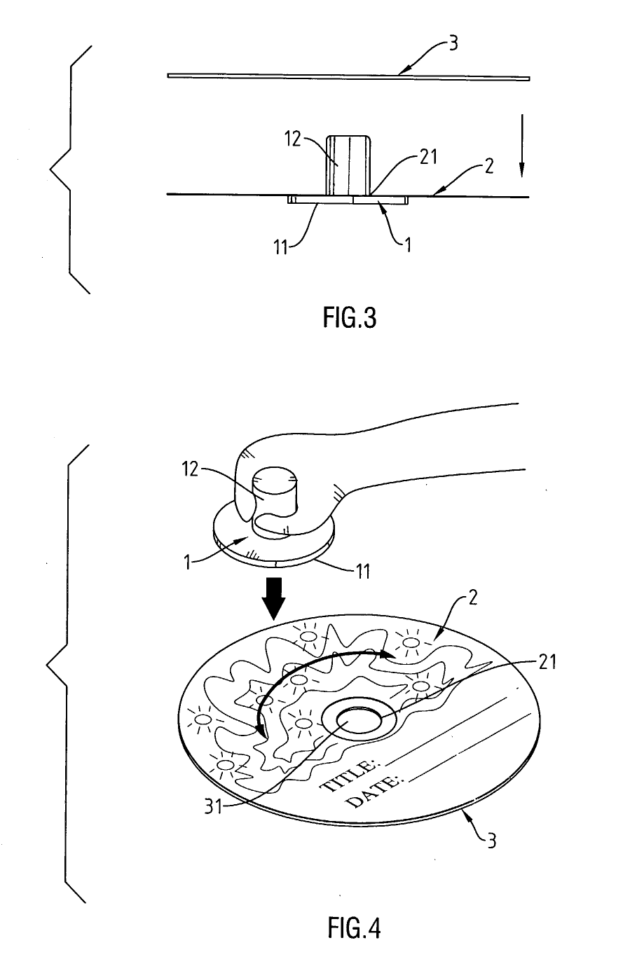

Please refer to FIGS. 3 and 4. The outer diameter of the label 2 equals to that of the CD 3 and the diameter of the central hole 21 of the label 2 coincides with that of the central column 12 of the label-pasting mechanism 1, allowing the central column 12 to pass through the central hole 21. Moreover, since the diameter of the central column 12 of the label-pasting mechanism 1 tallies with that of the circular hole 31 of the CD 3, the label 2 can be placed flatly on the surface of the contacting area 11 of the label-pasting mechanism after being passed through by the central column 12. What's more, the central column 12 can pass through the circular hole 31 of the CD 3, which combines the label 2 and the CD 3 as concentric circles.

After the label 2 is first combined to the CD 3 and the label 2 has not been pasted on the surface of the CD 3 completely, the user can use the contacting area 11 of the label-pasting mechanism 1 to contact with the label 2. Then, by holding the central column 12 to move the contacting area 11 around, the user can paste the label 2 completely and closely on the surface of the CD 3, preventing any air from existing between the label 2 and the CD 3. Therefore, pasting the label 2 on the CD 3 smoothly on the CD 3 with the label-pasting mechanism 1 enhances the convenience of using by oneself.

According to the forgoing structure, paste the label 2 completely on the CD 3 with the label-pasting mechanism 1 improves the difficulty of writing on the surface and filing the CD 3, while satisfies the requirement of filing by distinguishing the CD 3 with different color of labels 2.

What is claimed is:

1. A label-pasting mechanism for CDs shaped with a column standing at a center of a circular base, comprising a contacting area and a central column with a diameter equal to that of a CD's circular hole and that of a label's central hole, said protruding central column designed for holding as well as providing a positioning function for labels and CDs, a smooth surface of said contacting area allowing labels to be pasted completely and closely on a surface of CDs.
